(19) United States
(12) Patent Application Publication
(10) Pub. No.: US 2013/0132268 A1
(43) Pub. Date: May 23, 2013

(54) SYSTEMS AND METHODS FOR RECOVERING VEHICULAR COLLATERAL

(71) Applicant: Global Track GPS, LLC, Henderson, NV (US)

(72) Inventors: Frederick Arneman Cooper, Las Vegas, NV (US); Katherine Harrison Cooper, Las Vegas, NV (US); David Cooper, New Albany, OH (US); Taryn Stigall Cooper, Las Vegas, NV (US)

(73) Assignee: Global Track GPS, LLC, Henderson, NV (US)

(21) Appl. No.: 13/679,671

(22) Filed: Nov. 16, 2012

Related U.S. Application Data
(60) Provisional application No. 61/561,738, filed on Nov. 18, 2011.

(51) Int. Cl. G06Q 40/02

(52) U.S. Cl. CPC G06Q 40/025
USPC 705/38

(57) ABSTRACT

Systems and methods for securing collateral for a vehicle loan, when the loan is in a default condition. A Global Positioning System (GPS) tracking device may be installed within a vehicle which is a subject of the loan. If repossession of the collateral becomes necessary, all paperwork for the repossession may be automatically generated, and electronically submitted to the repossession agent. The repossession agent is able to receive location data for the vehicle through an application, such as a mobile “app.” After locating the vehicle, the repossession agent may visually inspect the vehicle, and then request that the vehicle be disabled via the application. The request may be received at a server, which then sends a signal to disable the vehicle. The repossession agent may then take possession of the disabled vehicle and return it to the lender.

### PRIORITY

This application claims priority to U.S. Provisional Patent App. No. 61/561,738, filed Nov. 18, 2011, and titled “Method of Retrieving Vehicular Collateral,” the entirety of which is hereby incorporated herein by reference.

### FIELD OF THE INVENTION

The systems and methods disclosed herein relate generally to collateral recovery, and more particularly, to the retrieval of vehicular collateral in which a device has been installed to provide locational data (e.g., Global Positioning System (GPS) data) for the collateral and, if requested, disable and/or communicate with the vehicle.

### BACKGROUND

Generally, vehicles, such as automobiles, have been financed through a personal loan system. A purchaser borrows money from a financial or other lending institution, takes title to the vehicle, and pays the loan balance in monthly payments, which amortize the full amount of the loan. Typically, the financial institution retains a lien interest against the title of the vehicle, and the loan is secured by a chattel mortgage on the vehicle.

The lending institution may recover or repossess the vehicle if the loan enters a default condition, as agreed to by the purchaser or as provided by law. For instance, a default condition may arise if loan payments are delinquent for a predetermined time interval and/or in a predetermined amount. Thus, the vehicle is collateral for the loan used to purchase the vehicle.

Thus, upon the occurrence of a default condition of the loan, the lending institution may seek to recover or repossess the loan collateral, i.e., the vehicle. In this case, the lending institution will typically authorize repossession personnel to recover the vehicle. The collateral recovery process is generally considered be a time-intensive and otherwise expensive endeavor, and potentially requiring extensive resources to locate and obtain the vehicle.

Typically, the repossession personnel begin the collateral recovery process with nothing more than the vehicle holder's last known billing address. However, this address may be invalid or out-of-date. Even if the address is valid, the vehicle may not be kept or stored at the address. Moreover, the individual responsible for the loan may be actively avoiding repossession, for example, by hiding the vehicle or otherwise avoiding detection or location of the vehicle by the repossession agent.

### SUMMARY

Accordingly, the systems and methods disclosed herein provide for greatly improved recovery of collateral, especially in instances in which the collateral comprises a mobile object such as a vehicle. For instance, disclosed embodiments are able to improve the repossession process in terms of speed, efficiency, cost, and safety.

In an embodiment, a method for securing a vehicle as collateral for a loan is disclosed. The method comprises using at least one hardware processor to: monitor a plurality of accounts for a default condition; detect the default condition for at least one of the plurality of accounts, wherein the detected account is associated with a vehicle; automatically generate one or more electronic repossession documents; transmit the one or more electronic repossession documents to a repossession agent; receive first locational data from a recovery device installed in the vehicle; and transmit second locational data derived from the first locational data to the repossession agent.

In an additional embodiment, a system for securing a vehicle as collateral for a loan is disclosed. The system comprises: at least one hardware processor; and one or more executable modules that, when executed by the at least one hardware, monitor a plurality of accounts for a default condition, detect the default condition for at least one of the plurality of accounts, wherein the detected account is associated with a vehicle, automatically generate one or more electronic repossession documents, transmit the one or more electronic repossession documents to a repossession agent, receive first locational data from a recovery device installed in the vehicle, and transmit second locational data derived from the first locational data to the repossession agent.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates a configuration of systems which may be utilized to recover a vehicle or other collateral, according to an embodiment;

FIG. 2 illustrates a block diagram of a recovery device, according to an embodiment;

FIG. 3 illustrates a flow diagram of a method for securing collateral, according to an embodiment; and

FIG. 4 illustrates an example device that may be used in connection with various embodiments described herein.

### DETAILED DESCRIPTION

Systems and methods for securing collateral for a loan, such as a vehicle for a vehicle purchase loan, are disclosed. At a high level, a GPS tracking device may be installed within the vehicle. If repossession of the vehicle becomes necessary, the system can automatically generate all of the required paperwork, and electronically transmit the generated paperwork to a designated repossession agent. The repossession agent may obtain locational data from the vehicle using a mobile application which is able to receive information from the GPS tracking device, either directly or through one or more servers, networks, or other relay mechanisms. After locating the vehicle, the repossession agent may visually inspect the vehicle, and, if necessary, request through the mobile application that the vehicle be disabled. The mobile application may communicate with the servers or other relay mechanisms, which may send a command to the GPS tracking device to disable the vehicle, or in some embodiments, the mobile application may even communicate directly with the GPS tracking device to disable the vehicle. The repossession agent may then take possession of the vehicle and return it to the lender or other appropriate entity.

The GPS tracking device may also be capable of detecting any physical tampering with the device, and transmit a tamper signal in response to any sensed tampering via cellular data communication technology. In addition, the lending institution may be able to verify operability of the GPS tracking device by having it periodically transmit signals. Thus, by ensuring operability and a lack of tampering, the lending institution can be confident that there is a high probability of retrieving the vehicle, should such a course of action become necessary. For instance, in some embodiments, a vehicle may be instantaneously located with a high degree of precision, disabled, and/or a vehicle alarm activated upon occurrence of a default condition.

In comparison, traditional methods of retrieving vehicular collateral typically provide only a last-known documented address for the obligor of the loan. This address may be invalid or out-of-date, or the vehicle may not be stored at the location. Moreover, the individual responsible for the vehicle may actively attempt to avoid repossession of the vehicle. As such, these traditional methods often entail long and costly endeavors. Accordingly, the systems and methods disclosed herein represent a significant advancement in the art.

Overview of System

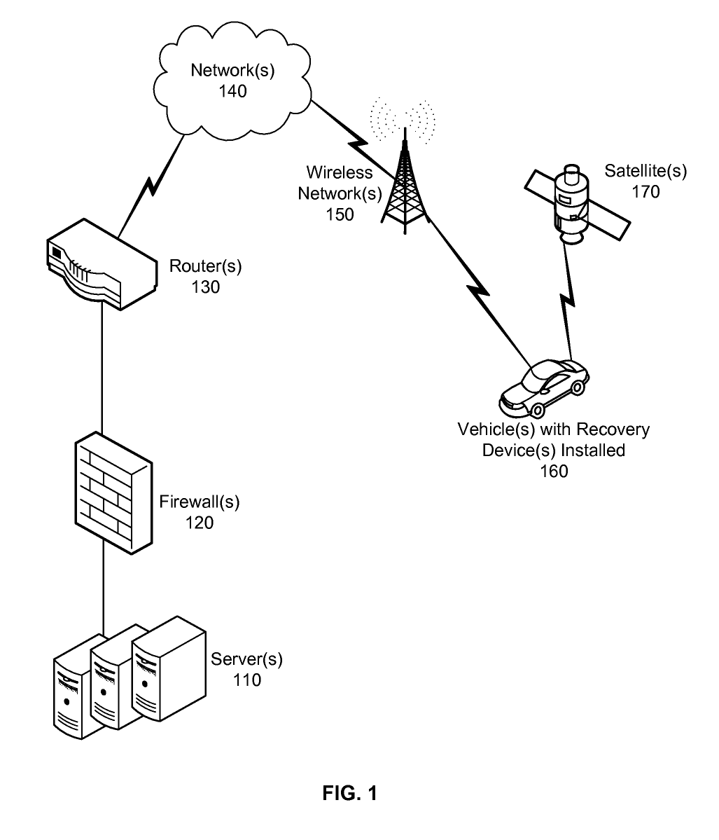

FIG. 1 illustrates a high-level diagram of various components which may be used in embodiments of the disclosed system for tracking collateral. In the illustrated embodiment, collateral 160 is shown as a vehicle. However, it should be understood that collateral 160 is not limited to vehicles, and may comprise any other type of collateral. Collateral 160 has an installed tracking device or recovery device, which is capable of receiving and/or generating locational data. The recovery device may have been installed during manufacture of the collateral or at a subsequent time (e.g., upon sale or delivery, for example, as a condition of the loan). In an embodiment, this locational data may comprise or be based on data received from satellite(s) 170, which may be GPS satellite(s). The recovery device may then transmit the locational data (e.g., GPS data) to server(s) 110. Specifically, the recovery device of collateral 160 transmits the locational data to a wireless network 150 (e.g., a cellular network), for example, using a wireless transmitter (e.g., a cellular transmitter). The wireless network 150 may relay the data to one or more other networks 140 (e.g., the Internet), which in turn, may relay the data to server(s) 110. In an embodiment, server(s) 110 may reside behind one or more firewalls 120 and/or one or more routers 130. In such an embodiment, the router 130 receives data packets, including the locational data from the recovery device, from network(s) 140, and directs the packets to server(s) 110 or a port or ports of server(s) 110 using a routing table or routing policy. For security, server(s) 110 may also reside behind one or more firewalls 120 which monitor and analyzes data packets to determine whether or not they should be forwarded (e.g., to server(s) 110) based on a predetermined set of rules.

In an embodiment, the recovery device installed in collateral 160 is also capable of receiving data from wireless network(s) 150, as well as from satellite(s) 170. In such an embodiment, server(s) 110 or other server(s) may transmit data through network(s) 140 and 150 to the recovery device of collateral 160, or to another device installed on or in collateral 160 which is capable of relaying the data to the recovery device.

It should be understood that server(s) 110 may be a single server or may comprise multiple servers. Furthermore, server(s) 110 may be dedicated servers or may, instead, be cloud instances, which utilize shared resources of one or more servers. It should be further understood that the data may be transmitted between sever(s) 110 and collateral 160 via standard communication protocols, as are well known in the art. In an embodiment, server(s) 110 may comprise or be communicatively coupled to one or more databases, which may be relational databases comprising any data related to the disclosed systems and methods, such as account information associated with one or more loans, leases, or other obligations. In an embodiment, this account information comprises a status of the loan (e.g., “current,” “in default,” etc.), which may be stored as a character string, binary or Boolean value, or in some other data type or form.

Example of Recovery Device

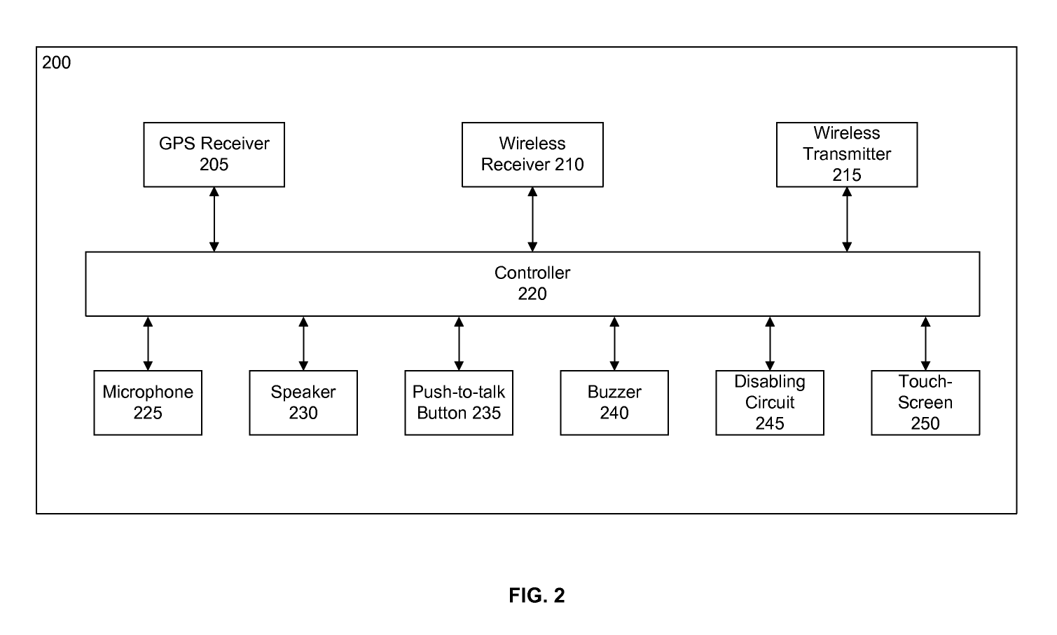

FIG. 2 illustrates an example tracking or recovery device which may be installed on or in collateral (e.g., collateral 160), according to an embodiment. Recovery device 200 may comprise a wireless receiver 210 (e.g., cellular receiver), wireless transmitter 215 (e.g., cellular transmitter), and controller 220. The wireless receiver 210 receives signals from wireless network(s) 150 (e.g., from a base station of a cellular network), and wireless transmitter 215 transmits signals to wireless network(s) 150 (e.g., to a base station of the cellular network). These signals may be distinct electromagnetic digital signals, such as Radio Frequency (RF) signals. In this manner, recovery device 200 may receive data from and transmit data to server(s) 110, for example, using conventional communication protocols. In an embodiment, some or all communications to and from wireless receiver 210 and wireless transmitter 215 may be encrypted using well-known or proprietary encryption techniques.

In some embodiments, wireless receiver 210 and wireless transmitter 215 may be the same device, i.e., a wireless transceiver (e.g., cellular transceiver, GSM antenna, and the like). This wireless transceiver may take the form of a cellular telephone or other cellular communication device. Alternatively, it should be understood that recovery device 200 need not necessarily comprise a wireless receiver 210. In such an embodiment, recovery device 200 may be passive in nature, and may continuously or periodically transmit locational data via wireless transmitter 215.

Wireless receiver 210 and wireless transmitter 215 are electrically coupled to controller 220. Controller 220 may be any type of digital processing device or computer, such as a microprocessor. The use of a microprocessor as controller 220 can provide versatility in programmability while permitting recovery device 200 to be as small in size as possible. It can be beneficial for recovery device 200 to be small in size, since its installation may be more easily concealed on or in collateral 160, which may be a vehicle. Concealment of recovery device 200 may help prevent someone from undesirably tampering with recovery device 200, and may be aesthetically desirable as well.

Recovery device 200 may also comprise a GPS receiver 205 or other module capable of determining a location of collateral 160. The GPS receiver 205 may use GPS satellite(s) 170 to derive locational data, such as GPS coordinates. For example, each GPS satellite 170 continually transmits a message comprising a time the message was transmitted and the satellite's position at the time the message was transmitted. GPS receiver 205 receives messages from one or more of GPS satellites 170, and typically, four or more GPS satellites 170. GPS receiver 205 then determines the transit time of each message and computes the distance to each GPS satellite 170 using the speed of light. The computed distances and satellite locations can then be used to compute the location of GPS receiver 205 using well-known navigation equations. This computation generally results in a determination of very precise locational data (e.g., GPS coordinates) for collateral 160.

Controller 220 may receive the computed locational data from GPS receiver 205. In an embodiment, controller 220 may process the locational data, and forward the processed data to wireless transmitter 215. Alternatively, controller 220 may not need to process the locational data prior to forwarding it to wireless transmitter 215. Recovery device 200 is capable of transmitting the processed or unprocessed locational data from GPS receiver 205 to server(s) 110 by transmitting the locational data from wireless transmitter 215 to one or more networks (e.g., wireless network(s) 150 and/or network(s) 140) providing a communicative path to server(s) 110.

In an embodiment, recovery device 200 is configured to alert a lending institution or agent of the lending institution if recovery device 200 has been physically tampered with. For example, recovery device 200 or components thereof (e.g., wireless transmitter 215, wireless receiver 210, GPS receiver 205, etc.) may comprise one or more hardware and/or software modules which are capable of sensing any physical tampering therewith. Tampering may be sensed via any of a variety of well-known techniques, such as electrical or electro-mechanical devices. In the event that tampering is sensed or otherwise detected, controller 220 or other module may be configured to generate and transmit a tamper signal in response to the detected tampering. Wireless transmitter 215 may receive the tamper signal from controller 220 and transmit the tamper signal to server(s) 110. Server(s) 110 may then notify appropriate personnel of the detected tampering via message, workflow item, and/or the like, or forward a notification to an appropriate interface for further processing. Advantageously, this tampering alert procedure increases the probability that recovery device 200 will function properly when desired (e.g., upon an occurrence of a default condition), since the lending institution may be made aware of tampering prior to an account entering into a default condition. Furthermore, the mere existence of the tampering alert procedure may deter acts of intentional damage to recovery device 200.

In the case that collateral 160 is a vehicle or other device having its own electrical system, recovery device 200 may be solely powered by the electrical system of collateral 160. Alternatively, recovery device 200 may be solely or additionally powered by a battery, which may be a rechargeable battery. For example, the rechargeable battery may be electrically connected to a generator or alternator of vehicular collateral and recharged during operation of the vehicular collateral. In this manner, recovery device 200 may utilize the rechargeable battery as a back-up or alternate power supply. Advantageously, use of a rechargeable battery to provide back-up power to recovery device 200 can mitigate against unwanted and possible intentional deactivation of recovery device 200 when the battery of the vehicular collateral is disconnected or when the vehicle is not in use or non-operational.

In an embodiment, recovery device 200 may be configured to receive a deactivation signal from server(s) 110, and deactivate collateral 160 in response to receipt of the deactivation signal. In this embodiment, recovery device 200 may comprise a disabling circuit or module 245, such as a vehicle disabling circuit, and controller 220 may be electrically coupled to disabling circuit 245. Disabling circuit 245 may be in electrical communication with any number of devices of collateral 160 which facilitate deactivation of collateral 160, such as, in the case that collateral 160 is a vehicle, an immobilization device, vehicle ignition, or fuel system. Thus, server(s) 110 may transmit a deactivation signal to wireless receiver 210 of recovery device 200, and controller 220 may process the deactivation signal received from wireless receiver 210 and initiate deactivation of collateral 160 via disabling circuit 245. Methods of deactivating collateral 160, such as immobilization of vehicular collateral, are well-known in the art, and it is contemplated that any of these well-known methods may be used. Accordingly, such methods will not be discussed in detail herein. In an embodiment, controller 220 or deactivation circuit 245 may also initiate an alarm, such as a vehicle theft alarm, in addition to or instead of deactivating collateral 160.

In embodiments, recovery device 200 may comprise a microphone 225, speaker 230, push-to-talk button 235, buzzer 240, touch-screen interface 250, and/or memory (not shown), all of which may be electrically coupled to controller 220. It should be understood that while the connections between controller 220 and the various modules are shown as bidirectional, one or more of these connections may be unidirectional. Furthermore, it should be understood that one or more of the various components or modules of recovery device 200 may be capable of being connected, disconnected, or replaced, for example, via socket or pin connections with controller 220.

In embodiments which utilize microphone 225 and/or speaker 230, recovery device 200 may provide communications between the lending institution (or an agent of the lending institution) and the obligor or other operator of collateral 160. For example, two-way communications may be provided via microphone 225 and speaker 230. Thus, if an account of the obligor enters into a delinquent or default condition, the lending institution may contact the obligor via recovery device 200, and attempt to rectify the delinquent or default condition. In addition, a service may be provided whereby an operator of collateral 160 may alert an agent that collateral 160 is not functioning properly (e.g., mechanical difficulty), provide the location of collateral 160, and identify what type of help is requested and when it is needed.

In embodiments which utilize microphone 225 and a push-to-talk button 235, an obligor or other operator of collateral 160 may be permitted to contact the lending institution (or an agent of the lending institution), via wireless receiver 210 or a cellular phone (e.g., connected via Universal Serial Bus (USB), Bluetooth™, or other technology), by pressing a button installed on or in collateral 160. Thus, if collateral 160 is a vehicle which has been disabled (e.g., due to a delinquency or default condition), and an emergency situation arises requiring use of the vehicular collateral, the obligor may contact the lending institution to have the vehicle reactivated. In response, the lending institution may transmit a reactivation signal from server(s) 110 to wireless receiver 210, and controller 220 may process the signal received from wireless receiver 210 and initiate reactivation of the vehicular collateral via an enabling circuit, which may be the same device as disabling circuit 245 or different from disabling circuit 245.

In embodiments which utilize a display or touch-screen interface 250, the lending institution or other entity may communicate with the obligor or other operator of collateral 160 via display or touch-screen interface 250. In an embodiment, the lending institution may communicate information, such as account information, via a Short Message Service (SMS) message or other messaging service, and this information may be displayed on a display, which may comprise a touch-screen, installed in or on collateral 160 (e.g., in the center console of vehicular collateral). This information may be transmitted from server(s) 110 and received at wireless receiver 210. For example, the communicated information may comprise the status of the loan, a confirmation of payment, a warning about a past due amount or delinquency or default condition, a notification that the collateral will be or is being disabled or deactivated, a notification that the obligor is close to completing the payment obligations of the loan, marketing messages (e.g., advertisements for other opportunities which may be of interest to the obligor), and any other message or type of message that the lending institution may desire or deem necessary to communicate to the obligor or operator of collateral 160. In addition, display or touch-screen interface 250 may provide bidirectional communication, such that the obligor or operator of collateral 160 is able to communicate with the lending institution, for example, by composing a response or other message via touch-screen interface 250. The composed message(s) may then be received and processed by controller 220, and transmitted by wireless transmitter 215 to server(s) 110. Messages received from the obligor or operator at server(s) 110 may then be communicated to an appropriate agent or interface of the lending institution.

In an embodiment, the message transmitted by the obligor to the lending institution via interface 250 may be a payment to the lending institution. For example, the obligor may enter (e.g., via a physical or virtual keyboard) or speak (e.g., via microphone 225) his or her payment information (e.g., credit/debit card number, expiration date, Card Verification Value (CVV), billing address or Zip Code, and/or bank account number and/or routing number). In embodiments in which microphone 225 is used to enter payment information, voice-recognition software may be used (e.g., stored in memory and executed by controller 220) to convert the spoken information into text and encode and/or encrypt the information prior to transmission to server(s) 110. Once the payment information is received, it may be communicated to an appropriate agent or interface of the lending institution, which may utilize the payment information to automatically or manually apply a payment to the obligor's account. In this manner, an obligor has the ability, and may have the opportunity, to resolve a delinquency or default condition, even if repossession personnel are already on site and preparing to recover the vehicle. By making payment through interface 250 of recovery device 200, the obligor may bring the loan current, resulting in immediate or near-immediate termination of the repossession efforts.

In an embodiment, recovery device 200 may further comprise an electrical cable for connection to an electrical power source of collateral 160 (e.g., vehicle battery), a socket for a Subscriber Identity Module (SIM) card for wireless communications, a socket connection for a handset device, and/or an accessory (ACC) input (none shown).

Overview of Method

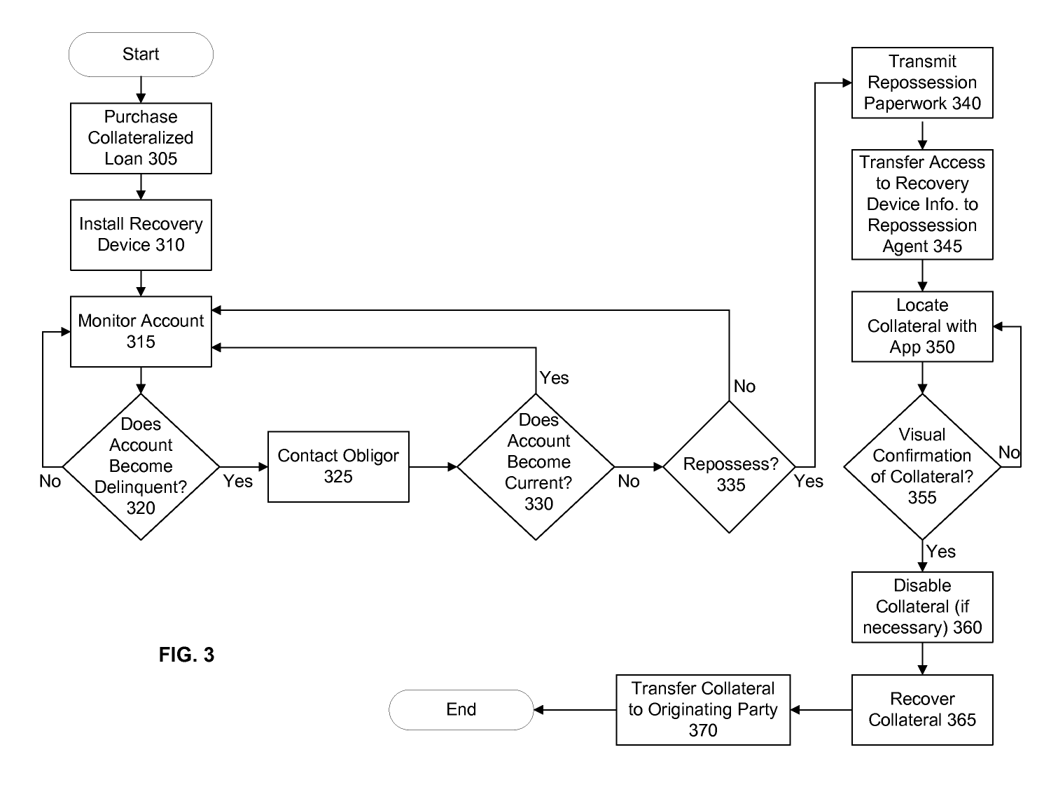

FIG. 3 illustrates a high-level process for securing collateral, according to an embodiment. Initially, in step 305, it is contemplated that a lending institution, such as bank or other financial institution, makes a loan, purchase agreement, lease agreement, rent agreement, or other arrangement with a borrower involving collateral. All such arrangements will be referred to herein simply as an “account.” In addition, it should be understood that the party or parties seeking to secure, recover, repossess, or otherwise seize the collateral may comprise one or more of a bank, savings and loan, mortgage company, credit union, vehicle dealership, vehicle manufacturer, leasing agent, collection agency, or any other lending or financial institution or agent or contractor thereof. All such entities will be referred to herein simply as a “lending institution.” The holder or possessor of the collateral (e.g., vehicle) may be the individual responsible for payment of the account and may be referred to as the “purchaser,” “debtor,” “borrower,” “lessee,” “operator,” or “obligor.”

In an embodiment, the subject of the account is a vehicle, with the vehicle serving as collateral for the account. The term “vehicle,” as used herein, may include, without limitation, an automobile, truck, motorcycle, boat, house boat, airplane, helicopter, horse trailer, mobile home, recreational vehicle, heavy machinery, tractor, and other device used for transportation or capable of movement or of being moved. However, while embodiments will be described herein primarily in the context of vehicular collateral, it should be understood that the systems and methods described herein are not so limited, and may be used with other types of collateral and in other contexts.

Referring again to FIG. 3, in step 310, a recovery device—embodiments of which are described in greater detail elsewhere herein—may be installed on or within the collateral (e.g., collateral 160), which may be a vehicle. The recovery device may be installed prior to, at the time of or subsequent to receipt of the collateral by the obligor or delivery of the collateral to the obligor. The recovery device may receive and/or generate locational data, and may be capable of transmitting the locational data through a transmitter, such as a cellular transmitter. In an embodiment, the locational data comprises, or is generated from, GPS data (e.g., received from GPS satellite(s) 170).

In step 315, the obligor's account with the lending institution is monitored. This monitoring may be performed by a server, such as server(s) 110. For instance, account information for the obligor may be stored (e.g., in one or more databases) on server(s) 110 or on separate server(s) or device(s) communicatively connected to server(s) 110. This account information may be automatically monitored by server(s) 110. For example, a thread (or other executable module) executing on server(s) 110 may continuously or periodically retrieve at least a portion of account information or loan status information stored in one or more database(s) and compare the information to a delinquency condition comprising one or more predetermined criteria. If the information matches the predetermined criteria, the thread may initiate further processing.

For example, in step 320, it is determined whether or not an account has become delinquent. In this case, the predetermined criteria may comprise a duration of delinquency (e.g., a number of months past due, a predetermined interval after which the account is not paid current, etc.) and/or an amount of delinquency (e.g., an amount or percentage of a balance past due). If the account has not become delinquent, as defined by the predetermined criteria, no action is performed, but the account will continue to be monitored in step 315. However, if it is determined that the account is delinquent, as defined by the predetermined criteria, an action is initiated.

This action may be the initiation of contact with the obligor, as illustrated in step 325. In an embodiment, this contact may be automatically initiated (e.g., without human intervention). For example, server(s) 110 may generate a communication (e.g., email, postal mail, text message, automated voice message) which is automatically sent to a contact destination (e.g., email address, postal address, telephone number) associated with the obligor. Alternatively or additionally, the server(s) 110 may automatically generate a communication or workflow task which notifies a human operator to contact the obligor. It should be understood that, in either case, contact information for the obligor, such as the described contact destinations, may be stored in the account information for the obligor. In an embodiment, communications may be escalated if the obligor fails to respond to one or more previous communications.

A delinquent obligor may be given a certain amount of time or number of communications before repossession of the collateral is initiated. For instance, following the expiration of a predetermined time period after the determination of delinquency in step 320, in step 330, it may be determined whether or not the formerly delinquent account has become current. For example, in step 320, a delinquent account may be flagged, and, in step 330, a thread (or other executable module) executing on server(s) 110 may continuously or periodically retrieve at least a portion of account information and compare the information to a default condition, comprising one or more predetermined criteria, to determine whether repossession should be initiated. If it determined that the account has become current, in step 330, a repossession process is not initiated, but the account continues to be monitored in step 315. Otherwise, if it is determined that the account is in default, a repossession process may be initiated in step 335.

It should be understood that steps 325 and 330 provide for a grace period. In alternative embodiments, such a grace period may be implemented differently and/or may be governed by law. Alternatively, a grace period (e.g., steps 325 and 330) may be omitted altogether, and the account may be determined to be in default if it is determined, in step 320, that an account has satisfied a delinquency or default condition.

If an account is determined to be in default, the repossession process may begin in step 335, at which point approval may be required. This approval may require human interaction with the server(s) 110, e.g., using one or more user interfaces. Alternatively, approval may be automatically provided if certain predetermined criteria are satisfied (e.g., history of prior delinquencies, amount of loan, type of loan). If repossession is not approved, then the account may continue to be monitored in step 315 or some other processing or handling of the account may be performed. However, if repossession is approved, then repossession is commenced.

When or after it is determined that an account is in a default condition, a data link (e.g., cellular data link) may be established between the server(s) 110 and the recovery device (e.g., GPS tracking device) installed on or in collateral 160. For example, if the loan status is switched to a default condition, server(s) 110 may generate and transmit a request signal to recovery device 200. Wireless receiver 210 of recovery device 200 receives the request signal from server(s) 110 via wireless network 150, thereby establishing a data link between server(s) 110 and recovery device 200. Wireless receiver 210 transmits the request signal to controller 220, which processes the request signal. In response to the request signal, controller 220 transmits locational data, received from or generated from data received from GPS receiver 205 and representing the location of collateral 160, to server(s) 110 via the established data link. The locational data may comprise any type of information capable of representing a location, such as coordinates of a geographic coordinate system (e.g., GPS coordinates, latitude and longitude coordinates), a street address, and/or the like.

The locational data, sent from recovery device 200, may be received at server(s) 110, optionally processed, and then served to one or more client applications, such as a browser application or smart phone application (“app”), residing on a user device. For example, server(s) 110 may be communicatively connected to one or more user device(s) via network(s) 140 and/or wireless network(s) 150. The network(s) may comprise the Internet, and server(s) 110 may communicate with the user device(s) through the Internet using standard transmission protocols, such as HyperText Transfer Protocol (HTTP), Secure HTTP (HTTPS), File Transfer Protocol (FTP), secure forms of FTP (e.g., SFTP, FTPS) and the like. User device(s) may comprise any type or types of computing devices capable of wired and/or wireless communication, including without limitation, desktop computers, laptop computers, tablet computers, mobile devices such as smart phones or other mobile phones or devices, and even other servers. Server(s) 110 may comprise web servers which host one or more websites or web services.

In embodiments in which a website is provided, the website may comprise one or more user interfaces, including, for example, web pages generated in HyperText Markup Language (HTML5 or other HTML standard) or other language. Server(s) 110 may transmit or serve these user interfaces in response to requests from the user devices. The requests to server(s) 110 and the responses from server(s) 110, including the user interfaces, may both be communicated through one or more network(s) 140 and/or 150, which may include the Internet, using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like. Server(s) 110 may also respond to other requests from user devices(s) or other systems. For example, a user device may submit data (e.g., user data, form data, etc.) to be stored in one or more databases locally and/or remotely accessible to server(s) 110. Any suitable database may be utilized, including without limitation MySQL, Oracle, IBM, Microsoft SQL, Sybase, Access, and the like, including cloud-based database instances. Data may be sent to server(s) 110, for instance, using the well-known POST request supported by HTTP. This data, as well as other requests, may be handled, for example, by a servlet or other server-side web technology executed by server(s) 110.

In embodiments in which a web service is provided, server(s) 110 may receive requests from user device(s) or other systems, and provide responses in eXtensible Markup Language (XML) and/or another suitable format. In such embodiments, server(s) 110 may provide an application programming interface (API) which defines the manner in which other system(s) may interact with the web service. Thus, the other system(s), which may themselves be servers, can define their own user interfaces, and rely on the web service to implement the backend processes, functionality, storage, etc., described herein.

In an embodiment, the locational data may be represented on a graphical map interface served by server(s) 110 and displayed by the client application (e.g., browser, smart phone “app”). For example, an icon may be overlaid on a map interface at the location indicated by the locational data. In this manner, the general whereabouts of collateral 160 (e.g., vehicle) may be known to the lending institution or agent of the lending institution as early as the loan status enters a default condition. However, it should be understood that tracking of collateral 160 may not necessarily begin immediately upon occurrence of a delinquency or default condition, but rather, may start at any time after installation of recovery device 200 (step 310 in FIG. 3) and prior to recovery of collateral 160 (step 365 in FIG. 3), depending on the particular policy or procedure of the lending institution.

In an embodiment, the locational data may be stored by server(s) 110 for future use, e.g., in one or more local or remote databases accessible to server(s) 110. Thus, if recovery device 200 is subsequently damaged or rendered inoperable and the loan status is in a default condition, the stored locational data may be retrieved to help identify the probable location or locations of collateral 160. For example, the last-known location of the collateral 160 may provide a starting point that a repossession agent can use to locate the collateral 160. Similarly, a plurality of known prior locations may be used to determine a plurality of potential locations or identify patterns of movement of collateral 160 to aid a repossession agent in locating or predicting the location of collateral 160.

In an embodiment, a verification procedure may be performed for recovery device 200 to ensure that recovery device 200 is operating correctly. This verification procedure may comprise periodically establishing a data link between server(s) 110 and recovery device 200 at predetermined time intervals prior to an occurrence of a default condition. The predetermined intervals may be daily, weekly, monthly, etc. At each predetermined interval, server(s) 110 generate and transmit a request to wireless receiver 210, which is received and processed by controller 220. Controller 220 then generates and transmits a response or signal, which may or may not comprise locational data of collateral 160, to server(s) 110 via wireless transmitter 215. Alternatively, controller 220 may automatically generate and transmit a signal at predetermined intervals, i.e., not in response to a request from server(s) 110. Receipt of a signal by server(s) 110 verifies the operation of recovery device 200, including wireless receiver 210 and/or wireless transmitter 215. In embodiments in which the verification signal comprises locational data, the locational data, periodically acquired by server(s) 110 through the verification procedure, may be stored for future use as discussed elsewhere herein.

In the event that a verification signal is not received by server(s) 110 during the verification procedure, server(s) 110 may initiate a notification. For instance, a module of server(s) 110 may alert the lending institution or an agent of the lending institution, through well-known messaging, interfaces, and/or workflow processes, that the recovery device 200 failed the verification procedure. Accordingly, the alerted party may then initiate a follow-up procedure, for example, by contacting the obligor and correcting any problems or defects in recovery device 200. In this manner, the lending institution can increase the probability that recovery device 200 will function as designed to facilitate recovery of collateral 160 upon an occurrence of a default condition.

In alternative embodiments, other methods, many of which are well-known in the art, may be used to derive the locational data for collateral 160. For instance, in a simple embodiment, the transmission of a signal by wireless transmitter 215 may itself provide locational data. In this case the signal need not comprise any locational data, and may, instead, comprise identifying data (e.g., an identifier of the signal and/or of collateral 160). Transmission of the signal provides directional data which can be used by a receiver to locate the emanating source (i.e., recovery device 200 of collateral 160). For example, server(s) 110 may be replaced by a mobile device comprising a wireless receiver capable of directionally and directly receiving the transmitted signal from wireless transmitter 215, such that it can determine the direction, relative to the mobile device, from which the signal is being received. Alternatively, server(s) 110 may be communicatively connected to a plurality of mobile or fixed base stations or terminals or an array of antennas which are directionally sensitive, such that triangulation techniques may be employed to locate the source of the signal transmitted by wireless transmitter 215 of recovery device 200.

Returning to FIG. 3, in step 340, paperwork required for repossession may be generated by one or more modules executed on or interfaced with server(s) 110. These modules may electronically and automatically fill in electronic templates of all paperwork required for the repossession process of collateral 160, including all necessary information concerning the obligor or operator and collateral identification (e.g., Vehicle Identification Number, license plate number, etc.). The modules may ensure that the filled-in paperwork comply with state law and/or other applicable laws, regulations, or policies. The modules may further provide user interfaces which allow a user to e-sign the filled-in paperwork, and select a repossession agent from a directory comprising a plurality of repossession agents. Once the repossession agent is selected or otherwise designated, the modules may fill additional information into the paperwork, based on the selected repossession agent, such that the paperwork is populated with all of the information legally and internally required for the repossession agent to perform the assigned repossession. Alternatively, all information may be filled into the paperwork following selection or designation of the repossession agent.

In an embodiment, the particular template(s) chosen to generate the paperwork may be associated with and specific to particular repossession agents and/or particular locations (e.g., states) in which the repossession will occur or whose law, regulations, or policies will apply to the repossession. The modules may also automatically, or upon completion of an approval, review, or quality control process, transmit the filled-in paperwork to a repossession agent. It should be understood that the term “paperwork,” as used herein, may comprise electronic documents. This paperwork may be transmitted electronically (e.g., via email, fax, or to an interface of a workflow application of the repossession agent) or may be printed and sent in hard copy form to the repossession agent.

In step 345, the lending institution may transfer the ability to track, communicate with, and/or disable collateral 160 to a repossession agent. For example, the lending institution may provide the repossession agent with access to server(s) 110 via a client application, such as a browser application or mobile application (commonly referred to as an “app”), as well as a unique identifier of collateral 160 which can be used with the client application and/or server(s) 110 to track and/or communicate with collateral 160. The lending institution may limit the repossession agent's access to server(s) 110 to data related to the particular collateral 160 being assigned to the repossession agent. The function of transmitting the repossession request to the repossession agent may allow the agent to have access to all or some of the functions and features provided by recovery device 200 and/or server(s) 110 described herein.

In step 350, the repossession agent may utilize the client application to locate collateral 160. For example, the client application may be a smart phone “app” or other mobile application. Alternatively, the client application may simply be a browser application which communicates with a web server of server(s) 110 (e.g., via HTTP and/or HTTPS). Repossession personnel may install the client application on a mobile device, such as a smart phone, which they can carry with them in the field. The client application communicates with server(s) 110 (e.g., via one or more networks, including the Internet, and a web server executing on server(s) 110), and may request the location of collateral 160. In response, server(s) 110 may retrieve locational data for collateral 160. This locational data may be retrieved from memory (e.g., a database) or server(s) 110 may transmit a request to wireless receiver 210 and receive the locational data from wireless transmitter 215 in response to the request. In either case, the locational data may be communicated to the client application in response to the client application's request for the location of collateral 160. As discussed elsewhere herein, the client application may display the location of collateral 160, overlaid on a graphical map interface, on the mobile device of the repossession personnel. The client application may also display the repossession personnel's location (e.g., as received from a GPS receiver of the repossession personnel's mobile device, or inputted by repossession personnel) in relation to the location of collateral 160. In addition, the client application may provide directions and/or navigational cues, including audio cues, to guide the repossession personnel towards collateral 160. In an embodiment, server(s) 110 continually send updates of the location of collateral 160 to the client application, such that the client application can update the displayed location of collateral 160 in real time or near-real time.

Additionally, repossession personnel may be able to communicate with the obligor or operator of collateral 160 through the client application. For example, the client application and/or server(s) 110 may relay voice or text communications from a transmitter of the repossession personnel's mobile device to wireless receiver 210 of recovery device 200, and relay such communications from wireless transmitter 215 of recovery device 200 to a receiver of the repossession personnel's mobile device. In an embodiment, repossession personnel (or other user) may push a “connect” button, which may be a virtual or physical button, on their mobile device (e.g., smart phone), which calls collateral 160, either directly or indirectly via server(s) 110, and which may be auto-answered (e.g., after a certain number of rings, such as 5 rings) by recovery device 200, giving the user direct contact with an operator of collateral 160. Alternatively or additionally, the client application may connect repossession personnel directly to a contact destination (e.g., personal phone number) associated with the obligor or display or otherwise provide such contact information to the repossession personnel to facilitate communication with the obligor.

In an embodiment, in step 360, repossession personnel may request, via the client application, that collateral 160 be deactivated. The deactivation request may be sent by the client application to server(s) 110. Alternatively, the lending institution may itself request deactivation of collateral 160 (e.g., automatically, or by an employee or agent via a client application). In response to the deactivation request, server(s) 110 may transmit a deactivation signal to wireless receiver 210 of recovery device 200. Controller 220 of recovery device 200 may receive and process the deactivation request from wireless receiver 210. Based on the deactivation request, controller 220 may then initiate disablement of collateral 160 via disabling circuit 245. In an embodiment, disabling circuit 245 may return an acknowledgement and/or confirmation that collateral 160 has been successfully disabled to controller 220. Based on the acknowledgement and/or confirmation, controller 220 may transmit an acknowledgement or confirmation via wireless transmitter 215 to server(s) 110, which, in turn, may transmit an acknowledgement and/or confirmation of the deactivation of collateral 160 to the client application which requested deactivation.

In the case that collateral 160 is a vehicle, visual confirmation that the vehicle is not currently being operated may be required, in step 355, prior to deactivation, to ensure the safety of passengers and bystanders. Alternatively, recovery device 200 may be configured to detect whether the vehicle is currently in operation and refrain from activating disabling circuit 245 if the vehicle is in operation, or wait until it detects that the vehicle is no longer in operation to activate disabling circuit 245. In this case, repossession personnel could request deactivation of collateral 160 via the client application prior to visual identification of collateral 160, thereby preventing further movement or relocation of collateral 160 once it has stopped, and facilitating recovery.

The ability of a repossession agent to disable collateral, such as a vehicle, prior to repossession represents a significant improvement over prior art methods. In the field of repossession, hundreds of injuries are sustained each year as a result of obligors reacting violently towards repossession personnel. These violent acts can end with the repossession personnel and/or obligor sustaining injury, including serious injury and even death. By providing the ability to disable vehicular collateral prior to a repossession attempt, incidences of violence can be reduced, thereby reducing injuries and even saving lives. For instance, repossession personnel may visually inspect a vehicle to ensure that disablement will not risk the safety of the obligor or an operator of the vehicle. The repossession personnel can then disable the vehicle, using the described systems and methods, in order to reduce the threat posed to the involved parties during repossession. Specifically, if the vehicle is disabled, the risk of someone being injured by movement of the vehicle is eliminated. In addition, once the obligor or operator of the vehicle realizes that it has been disabled and is no longer useable, he or she may be less willing to resort to violence to prevent repossession of the vehicle.

It should be understood that deactivation of collateral 160 may not always be necessary or desirable, and may be omitted in some embodiments or scenarios. In other words, with reference to FIG. 3, step 360 may be omitted. In any case, whether or not collateral 160 has been disabled or deactivated, collateral 160 may be recovered in step 365 by the repossession personnel. In other words, the repossession personnel may take possession of collateral 160. For instance, in the case that collateral 160 is a vehicle, repossession may involve towing the vehicle to a storage facility utilized by the repossession agent or by the lending institution. Once the collateral is secured by the repossession agent, the agent may utilize user interfaces of the client application or another method (e.g., email) to transmit a message to server(s) 110 or the lending institution comprising pertinent information regarding the repossession. For example, this information may comprise the current location of the recovered collateral, the condition of the collateral, photographs of the collateral, and the like. Server(s) 110 may receive this information and communicate the information or portions of the information to the lending institution, appropriate agent(s) of the lending institution, and/or interface(s). For example, the information may be communicated to the finance company or dealer associated with the recovered collateral.

Ultimately, in step 370, the collateral is transferred to the originating party, such as the lending institution, dealer, or other entity for disposition, thereby completing the collateral recovery process. In an embodiment, once the pertinent information and/or collateral is returned to the lending institution, the repossession agent's ability to track, communicate with, and/or disable the collateral through server(s) 110 is terminated or otherwise restricted. However, the repossession agent may retain access to the assignment and condition report. Furthermore, the repossession agent may be provided with access to an invoicing function (e.g., executed by server(s) 110 or by the client application), which the repossession agent can utilize upon completion of the repossession assignment to request or obtain payment from the lending institution.

Geo-Fence

In an embodiment, recovery device 200 can be used to implement a virtual geographically-defined fence or “geo-fence” around collateral 160. For example, the geo-fence may be defined by a polygon represented by three or more GPS coordinates, by a circle represented by a GPS coordinate and a radius, or by other means. The geo-fence is a geographic region in which collateral 160, which may be a vehicle, is permitted to operate without resulting in an alert condition. However, if collateral 160 travels outside of this geographic region, an alert or other notification may be transmitted to an agent or interface of the lending institution. For example, an email may be sent to an appropriate agent indicating that collateral 160 has traveled outside of the pre-designated geographic region, i.e., geo-fence.

It should be understood that the geo-fence may be implemented in a variety of ways. For example, the data representing the geo-fence (e.g., the coordinates defining the polygon or circle representing the geo-fence) may be stored in one or more databases accessible to server(s) 110. Server(s) 110 may then continuously or periodically compare locational data received continuously or periodically from recovery device 200 to the geo-fence data to determine whether the current location of collateral 160 is inside or outside of the geo-fence. Alternatively, the geo-fence data may be stored in a memory on recovery device 200. In this alternative embodiment, controller 220 of recovery device 200 may continuously or periodically compare locational data received from GPS receiver 205 to the geo-fence data to determine whether the current location of collateral 160 is inside or outside the geo-fence. If controller 220 determines that the current location of collateral 160 is outside the geo-fence, it may transmit an alert message or other notification to server(s) 110 via wireless transmitter 215.

In an embodiment, if it is determined that collateral 160 has traveled outside the geographic region represented by the geo-fence, server(s) 110 may automatically, or upon approval or the satisfaction of predetermined criteria, send a deactivation signal to wireless receiver 210 of recovery device 200, which relays the signal to controller 220. In response to the deactivation signal, controller 220 may initiate deactivation of collateral 160 via disabling circuit 245. Server(s) 110, controller 220, and/or disabling circuit 245 may delay deactivation until it is determined that it is safe to deactivate collateral 160. For example, in the case that collateral 160 comprises a vehicle, one or more of these components may be configured to wait until it has been determined that the vehicle has parked outside of the geographic region represented by the geo-fence to initiate deactivation of the vehicle.

The use of geo-fences in this manner can aid a lending institution in recovering collateral, such as a vehicle, in a situation where the lending institution cannot enter into a particular geographic region represented by the geo-fence, or cannot by law recover the collateral in the geographic region represented by the geo-fence. This situation may arise, for example, when a collateralized vehicle normally resides on a Native American reservation. Under such circumstances, the lending institution may be alerted when the vehicle travels outside of the reservation, and therefore, becomes recoverable. Furthermore, the vehicle may be disabled once it has parked outside the reservation, preventing the vehicle from returning to the reservation, and thereby facilitating recovery of the vehicle by a repossession agent.

It should be understood that the geo-fence can be beneficially used for other purposes as well. For example, the geo-fence can be used to limit the area in which collateral 160, which may be a vehicle, is able to be operated. If an operator of collateral 160 transports collateral 160 outside of the geographic region represented by the geo-fence, collateral 160 can be disabled. In this manner, the obligor or other operator is unable to utilize collateral 160 outside the geographic region represented by the geo-fence.

Example Devices

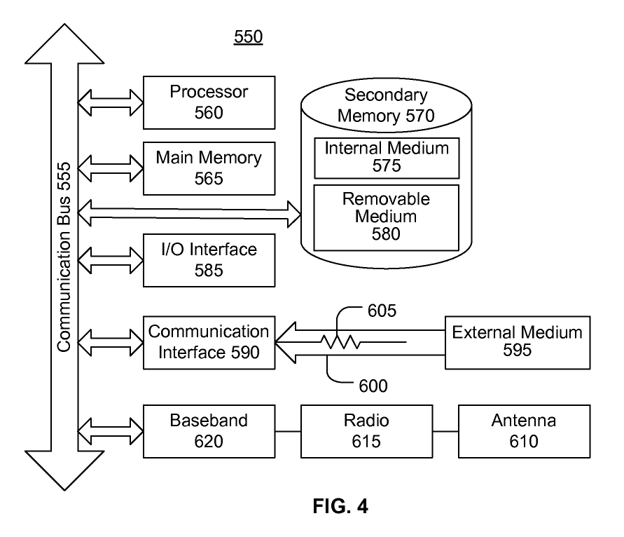

FIG. 4 is a block diagram illustrating an example wired or wireless system 550 that may be used in connection with various embodiments described herein. For example the system 550 may be used as, or in conjunction with, tracking device 200 (e.g., controller 220 may comprise processor 560, wireless transceiver 210/215 may comprise baseband 620, radio 615, and antenna 610, I/O interface 585 may comprise interface(s) with modules 205, 225, 230, 235, 240, 245, and/or 250, etc.), server(s) 110, and/or mobile device(s) or other devices used by the lending institution, agents of the lending institution, and/or repossession agents or personnel. The system 550 can be a conventional personal computer, computer server, personal digital assistant, smart phone, tablet computer, vehicle navigation and/or control system, base station controller, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with processor 560.

The processor 560 is preferably connected to a communication bus 555. The communication bus 555 may include a data channel for facilitating information transfer between storage and other peripheral components of the system 550. The communication bus 555 may further provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560, such as the overlay module and/or handwriting recognition module discussed above. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry-promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer-readable medium” is used to refer to any non-transitory computer-readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer-readable mediums are means for providing executable code, programming instructions, and software to the system 550.

In an embodiment that is implemented using software, the software may be stored on a computer-readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 and/or 570 may include various software modules (not shown) that were previously described.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent certain embodiments of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method for securing a vehicle as collateral for a loan, the method comprising using at least one hardware processor to:
monitor a plurality of accounts for a default condition;
detect the default condition for at least one of the plurality of accounts, wherein the detected account is associated with a vehicle;
automatically generate one or more electronic repossession documents;
transmit the one or more electronic repossession documents to a repossession agent;
receive first locational data from a recovery device installed in the vehicle; and
transmit second locational data derived from the first locational data to the repossession agent.

2. The method of claim 1, further comprising using the at least one hardware processor to receive a selection of the repossession agent from a plurality of repossession agents.

3. The method of claim 2, wherein automatically generating one or more electronic repossession documents comprises inputting data into one or more templates associated with the repossession agent.

4. The method of claim 1, further comprising using the at least one hardware processor to:
receive a disable request from a client application; and,
in response to the disable request, send a disable command to the recovery device, the disable command indicating that the recovery device should disable the vehicle.

5. The method of claim 1, further comprising using the at least one hardware processor to transmit a communication to the recovery device.

6. The method of claim 1, further comprising using the at least one hardware processor to receive the communication from a client application via at least one network prior to transmission of the communication to the recovery device.

7. The method of claim 1, further comprising using the at least one hardware processor to:
receive a tamper message from a recovery device, the tamper message indicating that tampering with the recovery device has been detected, and,
in response to the tamper message, generate an alert.

8. The method of claim 1, further comprising using the at least one hardware processor to:
detect a failure to receive locational data from a recovery device, and,
in response to the detected failure, generate an alert.

9. The method of claim 1, further comprising using the at least one hardware processor to store the first locational data.

10. The method of claim 1, wherein the second locational data comprises the first locational data.

11. The method of claim 1, wherein the second locational data comprises a graphic, and wherein the graphic comprises a map and an icon representing a location of the vehicle relative to the map.

12. A system for securing a vehicle as collateral for a loan, the system comprising:
at least one hardware processor; and
one or more executable modules that, when executed by the at least one hardware,
monitor a plurality of accounts for a default condition,
detect the default condition for at least one of the plurality of accounts,
wherein the detected account is associated with a vehicle,
automatically generate one or more electronic repossession documents,
transmit the one or more electronic repossession documents to a repossession agent,
receive first locational data from a recovery device installed in the vehicle, and
transmit second locational data derived from the first locational data to the repossession agent.

13. The system of claim 12, wherein the one or more executable modules further receive a selection of the repossession agent from a plurality of repossession agents.

14. The system of claim 13, wherein automatically generating one or more electronic repossession documents comprises inputting data into one or more templates associated with the repossession agent.

15. The system of claim 12, wherein the one or more executable modules further:
receive a disable request from a client application; and,
in response to the disable request, send a disable command to the recovery device, the disable command indicating that the recovery device should disable the vehicle.

16. The system of claim 12, wherein the one or more executable modules further transmit a communication to the recovery device.

17. The system of claim 12, wherein the one or more executable modules further receive the communication from a client application via at least one network prior to transmission of the communication to the recovery device.

18. The system of claim 12, wherein the one or more executable modules further:
receive a tamper message from a recovery device, the tamper message indicating that tampering with the recovery device has been detected, and,
in response to the tamper message, generate an alert.

19. The system of claim 12, wherein the one or more executable modules further:
detect a failure to receive locational data from a recovery device, and,
in response to the detected failure, generate an alert.

20. The system of claim 12, wherein the one or more executable modules further store the first locational data.
